(19) United States
(12) Patent Application Publication
(10) Pub. No.: US 2008/0219106 A1
(43) Pub. Date: Sep. 11, 2008

(54) Novel Clip System for Holding a Timekeeping Device

(76) Inventor: Alan Genender, Wheeling, IL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/684,269

(22) Filed: Mar. 9, 2007

(51) Int. Cl. G04B 37/14

(52) U.S. Cl. 368/316

(57) ABSTRACT

A timekeeping device comprising a casing with an aperture for securing a timepiece and a metallic hooking loop. The loop has an integral coupling member for selectively attaching the loop to an object. The coupling member comprises a first locking member integrally formed with the loop and a second slidable locking member axially biased toward the first member, whereby when axial pressure is applied to the first member, the second member moves axially away from the first member so as to create an opening to permit coupling of the timekeeping device to an object.

### CROSS REFERENCE TO RELATED APPLICATIONS

This application claims benefit to provisional application 60/780,701, filed on Mar. 9, 2006, entitled “Novel Clip System for Holding a Timekeeping Device”, which is incorporated by reference in its entirety.

### FIELD OF THE INVENTION

The present invention is directed to timepieces in general. The invention is more specifically directed to timekeeping devices, particularly a timekeeping device that has an integrally formed clip assembly for easy attachment to a user's clothing or outer garments, backpack, golf bag or other instrumentally such as a bicycle.

### BACKGROUND OF THE INVENTION

Most conventional watches and similar timepiece devices have been generally designed to be worn on a user's wrist. However, it is well known that watches and/or other devices have been constructed to be adorned on other parts of the body, such as on a ring or pendent.

With the increase in popularity of outdoor sports, such as hiking and bicycling, there is an increased need for a timekeeping device that can be worn on a user's outer garments and/or attached to the user's equipment. The current state of the art has not sufficiently fulfilled this need.

Accordingly, a time piece device that can be worn on a user's outer garments and/or attached to the user's equipment, particularly, a device that facilitates the securing to and removal thereof is desired. The present invention fulfills the void in the state of the art and meets the aforementioned and below mentioned objectives.

The patent literature has disclosed a number of U.S. patents directed toward watch clip technologies. U.S. Pat. No. 6,235,668 discloses a holder for securing a timepiece to an article, such as a backpack, tent, bicycle, or ski coat. In a preferred embodiment, the holder comprises a base which is securable to a watch case and a cover to shield the watch case when it is attached to the base. In one embodiment, the watch case is secured to the base by an elastic strap which is of a width and thickness to fit between the pins of the watch case and the body of the watch case. The cover can comprise a flexible band which is movable from an open position to a closed position and which can be locked in the closed position. Rings may be provided at opposing ends of the base to connect the base to an article. A belt may be fed through the rings to assist in connecting the holder.

Des. Pat. No. D445,039 is directed toward an ornamental design for a clip-on golf bag tag and logo watch.

U.S. Pat. No. 5,828,541 is a hanging structure of a timer or watch and the like, wherein an annular groove is provided on the periphery of the timer, the annular groove receives a plurality of balls provided on the ends of a plurality of hanging columns, the hanging columns can slide along the annular groove and around the timer under guiding of the annular groove, a hanging ring is provided on one end of each of the hanging columns for hanging keys or a remote controller for an automobile etc., so that the timer can have the functions of a pendant watch and a key ring, the hanging ringing is attached to a chain, so that the timer can be used as a pendant watch, an object of multifunction of the structure can thus be achieved.

U.S. Pat. No. 6,527,434 is a timekeeping device comprising a housing; timekeeping functionality positioned within the housing and a clip assembly integrally coupled to the housing, wherein the clip assembly comprises a first member and a second member hingedly coupled to the first member at a hinge point, whereby pressure against the second member causes the second member to rotate relative to the first member about the hinge point to permit coupling of the timekeeping device to an object of interest. In a particular configuration, the second member is releasably engageable with the first member. Additionally, the housing may include a receptacle for receiving a casing within which the timekeeping functionality that maintains the timekeeping functions is disposed. Preferably, the housing and at least the first member are formed from a unitary mold, and preferably from plastic. The object of interest, for example, may be a backpack, belt loop or bicycle.

The problem with the hinged device shown in U.S. Pat. No. 6,527,434 is that it can easily uncouple at unintended times. It would be desirable to provide a connectable time piece mechanism with a non-expensive connection system which can be easily attached and re-removed.

It is an object of the invention to provide a clip with an improved connection device which is more secure than designs shown in the prior art.

### SUMMARY OF THE INVENTION

In accordance with the present invention, an attachable timekeeping device is disclosed comprising a casing with a timepiece and loop affixed to the casing. The catch loop has an integral coupling member, the coupling member comprises a first member integrally formed with and extending from the casing, and a second coupling member axially biased toward the first member; whereby when axial pressure is applied in a first direction, the second member moves axially away from the first member creating an opening to permit coupling of the timekeeping device to an object.

In a further embodiment, the present invention is a timekeeping device comprising a casing with an aperture for securing a timepiece and a metallic hooking loop. The loop has an integral coupling member for selectively attaching the loop to an object. The coupling member comprises a first member integrally formed with the loop and a second slidable and telescoping locking member axially biased toward the first member, whereby when axial pressure is applied in a first, the second member moves axially away from the first member and telescopes over the loop, so as to create an opening to permit coupling of the timekeeping device to the object.

In still a further embodiment, the present invention is a timekeeping device comprising a casing with a first aperture for securing a timepiece and a second aperture for securing a compass and a metallic hooking loop. The loop has an integral coupling member for selectively attaching the loop to an object, the coupling member comprises a first locking member integrally formed with the loop and a second slidable and telescoping locking member axially biased toward the first member, whereby when axial pressure is applied in a first, the second member moves axially away from the first member and telescopes over the loop so as to create an opening to permit coupling of the timekeeping device to the object.

### BRIEF DESCRIPTION OF THE DRAWINGS

FIG. 1 is a perspective view of a timekeeping device constructed in accordance with a preferred embodiment of the present invention.

FIG. 2 is a partial prospective view of the timekeeping device of FIG. 1 that illustrates the operability of a clip assembly portion of the device.

FIGS. 3 and 4 are perspective views of the present invention illustrating an oppositely disposed attachment mechanism.

### DETAILED DESCRIPTION OF THE PREFERRED EMBODIMENT

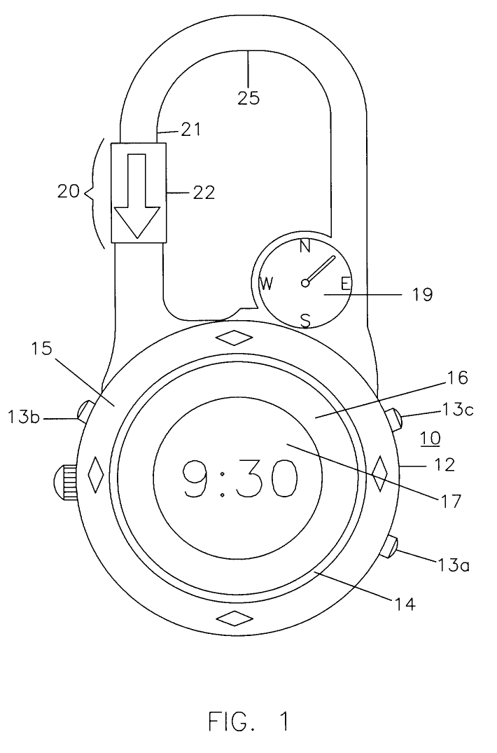

The present invention is described with reference to the enclosed Figures wherein the same numbers are used where applicable. FIG. 1 illustrates a time keeping device 10, constructed in accordance with the present invention. The time keeping device 10 is preferably comprised of a housing 12, and attached loop 25 for securing the housing 12 to an object such as a belt loop and a clip. In particular, the housing 12 includes a casing 15 and receptacle 14 within which the time device similar to the head of a watch 16 is enclosed. The casing 13 may or may not be integrally formed with the housing 12. The time keeping device 10 may comprise a mechanical or electrical time piece. Electrical and/or mechanical time pieces are well known to the art.

The casing 15 may include function buttons, for example buttons 13a-13c, which provides the functionality of the timekeeping device such as that disclosed in commonly owned U.S. Pat. Nos. 4,783,773; 4,780,864; 5,555,226 and 4,283,784, the disclosures of which are incorporated by reference as if fully set forth herein. For completeness however, it should be appreciated that casing 15 includes a display 17 and other appropriate components and features so as to provide a complete timekeeping device. The casing may include other functional features such as a compass 19.

In the preferred embodiment, clip assembly 20 is constructed as part of a loop 25 affixed to the housing 12. In the preferred embodiment, housing 12 may be integrally formed with clip assembly 20 so as to facilitate the fabrication of the system.

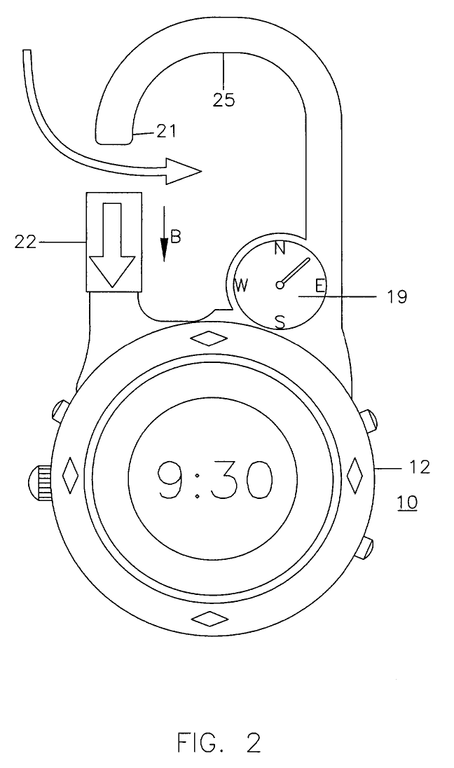

The clip assembly is now described with reference to FIGS. 1 and 2. The clip assembly 20 preferably comprises a first clip member 21, integrally formed with the loop 25. The clip assembly 20 also includes on oppositely disposed coaxial slidable second clip member 22, which is a spring biased toward the first member in a closed position. The second clip member has a telescoping outer sheath portion which telescopes over the loop 25. The spring biased slidable first clip assembly 21 facilitates the selective opening and closing of the loop 25, so as to create an opening in the loop 25 to attach the device to a belt loop or other object.

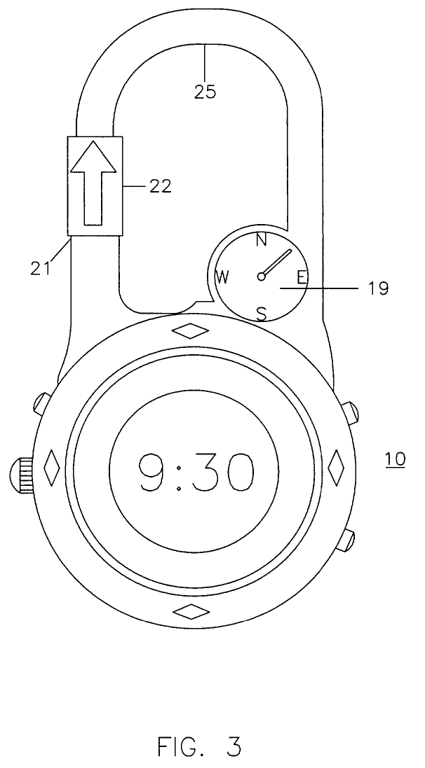

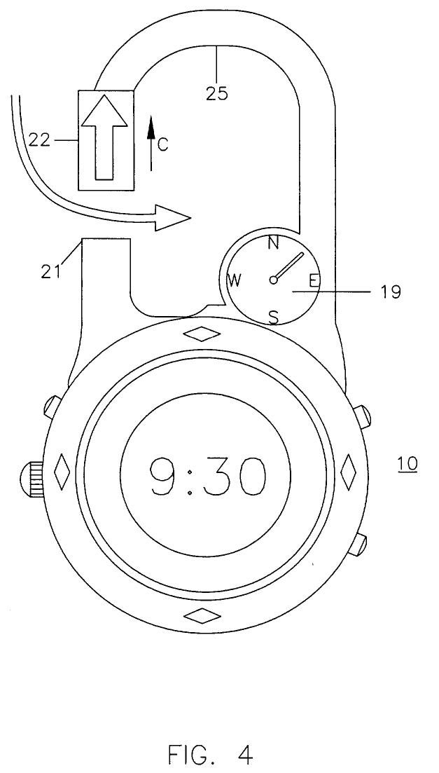

As shown in FIG. 2, the second clip assembly 22 is slidably moved from an open and closed position as shown in FIG. 2. In the closed position, the first member 21 and the second member 22 complete the closed loop configuration of the clip assembly 20 and the housing 12. This enables the loop 25 to catch onto and be secured to an object. The spring action of the biasing member such as an internal spring causes slidable engagement of the second member 22 into the first member 21. FIGS. 3 and 4 illustrate an embodiment of the invention in which the position of the first and second members is reversed on the loop.

While the preferred embodiment has been described with regard to the particular clip assembly configuration, the present inventors recognize that other clip assemblies are contemplated to be within the scope of the present invention. The invention secures the time keeping device 10 to an article of clothing such as a belt or beltloop, a backpack, a golf bag or another device such as a bicycle.

In view of the foregoing, the operation of the present invention is described. In particular, when a user desires to either adorn the time keeping device 10 to the user's article of clothing or other gear or device, the user needs to apply pressure or force to the second axial member 22. By manual activation in response to the application of pressure, the second locking member 22 slidably and axially disengages from first member 21 at arrow B in FIG. 2 and at arrow C in FIG. 4. In one embodiment, a biasing device such as, a biasing spring, biases the second member 22 toward the closed position. As such, the second member 22 substantially remains and/or returns to the closed position until a force is applied sufficient to counteract the force of the biasing spring.

Depending on the desired usage of the present invention, the display 17 and compass 19 may be oriented such that the display 17 faces the user when time keeping device 10 is worn on a belt buckle for example, or may face away from the user. This is a personal preference and only a matter of design choice and forms not part of the invention.

What has been disclosed herein is a unique construction that incorporates timekeeping features into a time keeping device 10 that can be quickly removed from or secured to a user's person such as by securing it to the user's a belt loop or other outerwear. Likewise, the timekeeping device disclosed herein can be easily coupled to a golf bag, backpack or other object when it is inconvenient or not possible to have a watch placed upon a wrist. Also, as stated above, it is within the scope of the present invention to employ other carabiner-type closure mechanisms, such as those mentioned herein above.

Although described in the context of preferred embodiments, it should be realized that a number of modifications to these teachings may occur to one skilled in the art. As should be appreciated, the scope of the present invention is not limited to a particular configuration of the housing 12, the clip assembly 20 and/or the first member 21 or second member 22 thereof. Rather, the present invention is directed to a unique integration of a timepiece and clip assembly having a biased member for rapid and easy coupling of the integrated device onto a user's clothing or belt, outer garments, backpack, golf bag or other equipment.

While the invention has been particularly shown and described with respect to preferred embodiments thereof, it will be understood by those skilled in the art that changes in form and details may be made therein without departing from the true scope and spirit of the invention.

I claim:

1. An attachable timekeeping device comprising:
a casing with a timepiece and loop affixed to the casing, the catch loop having an integral coupling member, the coupling member comprising a first member integrally formed with and extending from the casing, and a second coupling member axially biased toward the first member;
whereby when axial pressure is applied in a first direction the second member moves axially away from the first member creates an opening to permit coupling of the timekeeping device to an object.

2. A timekeeping device comprising:
a casing with an aperture for securing a timepiece and a metallic hooking loop, the loop having an integral coupling member for selectively attaching the loop to an object,
the coupling member comprising a first member integrally formed with the loop and a second slidable locking member axially biased toward the first member, whereby when axial pressure is applied in a first the, second member moves axially away from the first member so as to create an opening to permit coupling of the timekeeping device to the object.

3. A timekeeping device comprising:
a casing with a first aperture for securing a timepiece and a second aperture for securing a compass and a metallic hooking loop, the loop having an integral coupling member for selectively attaching the loop to an object,
the coupling member comprising a first locking member integrally formed with the loop and a second slidable and telescoping locking member axially biased toward the first member, whereby when axial pressure is applied in a first the, second member moves axially away from the first member and telescope over the loop so as to create an opening to permit coupling of the timekeeping device to the object.
